(19) United States
(12) Patent Application Publication
(10) Pub. No.: US 2026/0338930 A1
(43) Pub. Date: Oct. 29, 2026

(54) METHOD FOR CALIBRATING FREQUENCY MODULATED CONTINUOUS WAVE LIDAR AND FREQUENCY MODULATED CONTINUOUS WAVE LIDAR

(71) Applicant: Lunor Technology Co., Ltd., Beijing (CN)

(72) Inventors: Xuehui SHANG, Beijing (CN); Zhiwei QU, Beijing (CN); Weixing WANG, Beijing (CN); Yongqiang DENG, Beijing (CN)

(73) Assignee: Lunor Technology Co., Ltd., Beijing (CN)

(21) Appl. No.: 19/433,993

(22) Filed: Dec. 29, 2025

(30) Foreign Application Priority Data
Dec. 31, 2024 (CN) 202411999243.0

(51) Int. Cl. G01S 7/497; G01K 3/00; G01S 7/481; G01S 17/32

(52) U.S. Cl. CPC G01S 7/497; G01K 3/005; G01S 7/4817; G01S 7/4818; G01S 17/32

(57) ABSTRACT

Embodiments of the present application provide a method for calibrating a frequency modulated continuous wave (FMCW) LiDAR, and an FMCW LiDAR. The method includes: in a case where the FMCW LiDAR is to be calibrated, controlling a light emitting direction of a scanning device of the FMCW LiDAR to point to a preset monitoring link; transmitting a detection signal to the monitoring link and receiving an echo signal via the scanning device, and determining a detection distance corresponding to the monitoring link based on the echo signal, where the echo signal is formed after the detection signal passes through the monitoring link; and determining a ranging calibration parameter of the FMCW LiDAR based on the detection distance and a calibration distance corresponding to the monitoring link. Through the present application, the problem of high structural complexity and high cost of LiDARs is solved.

### CROSS-REFERENCE TO RELATED APPLICATION

This application claims priority to Chinese Patent Application No. 202411999243.0, filed on Dec. 31, 2024 and entitled “METHOD FOR CALIBRATING FREQUENCY MODULATED CONTINUOUS WAVE LIDAR AND FREQUENCY MODULATED CONTINUOUS WAVE LIDAR”, which is hereby incorporated by reference in its entirety.

### TECHNICAL FIELD

The present application relates to the field of LiDAR technologies, and in particular, to a method for calibrating a frequency modulated continuous wave LiDAR, and a frequency modulated continuous wave LiDAR.

### BACKGROUND

An FMCW (Frequency Modulated Continuous Wave) LiDAR (Light Detection And Ranging) is susceptible to environmental influences that affect both a laser's linewidth and a DDS (Direct Digital Synthesis, direct digital synthesis) hardware circuit, leading to degradation of the measurement accuracy. In related technologies, an additional optical path may be added for distance calculation, and related component(s) may be calibrated based on a result of the distance calculation.

However, adding the additional optical path not only increases structural complexity of the LiDAR, but also raises a cost of the LiDAR, making it difficult to widely apply such solutions in multi-laser systems. Therefore, the calibration methods for FMCW LiDARs in related technologies face issues of high structural complexity and high cost of LiDARs.

### SUMMARY

An embodiment of the present application provides a method for calibrating an FMCW LiDAR and an FMCW LiDAR, to at least solve the technical problem of high structural complexity and high cost of LiDARs in the calibration methods for FMCW LiDARs in related technologies.

According to an aspect of embodiments of the present application, a method for calibrating a frequency modulated continuous wave (FMCW) LiDAR is provided. The method includes: in a case where the FMCW LiDAR is to be calibrated, controlling a light emitting direction of a scanning device of the FMCW LiDAR to point to a preset monitoring link; transmitting a detection signal to the monitoring link and receiving an echo signal via the scanning device, and determining a detection distance corresponding to the monitoring link based on the echo signal, where the echo signal is formed after the detection signal passes through the monitoring link; determining a ranging calibration parameter of the FMCW LiDAR based on the detection distance and a calibration distance corresponding to the monitoring link.

According to another aspect of embodiment of the present application, a frequency modulated continuous wave (FMCW) LiDAR is further provided. The FMCW LiDAR includes: a scanning device, a monitoring link, and a controlling component; where the controlling component is configured to in a case where the FMCW LiDAR is to be calibrated, control a light emitting direction of the scanning device to point to the monitoring link; control the scanning device to transmit a detection signal to the monitoring link and receive an echo signal from the monitoring link, and determine an detection distance corresponding to the monitoring link based on the echo signal; and determine a ranging calibration parameter of the FMCW LiDAR.

According to yet another aspect of embodiments of the present application, a computer-readable storage medium is further provided, storing a computer program. The computer program is configured to execute the steps of any of the method embodiments described above when running.

According to the present application, by adding a reflection circuit at a fixed position within the device, in a case where an FMCW LiDAR is to be calibrated, a scanning device is controlled to transmit a detection signal to a monitoring link, to obtain an echo signal of the monitoring link. A detection distance corresponding to the monitoring link may be determined based on the echo signal of the monitoring link by analyzing frequency data. A ranging calibration parameters of the LiDAR may be calculated by comparing the detection distance with a calibration distance corresponding to the monitoring link, so that a detection distance of a detection target may be calibrated using the ranging calibration parameter to obtain an actual distance, thereby improving the ranging accuracy. Furthermore, the monitoring link is a fixed reflection circuit set within the LiDAR, which not only omits a complex optical path part and reduces the structural complexity of the LiDAR, but also lowers the calibration cost of the LiDAR, thereby solving the technical problem of high structural complexity and high cost of LiDARs in the calibration methods for FMCW LiDARs in related technologies.

### BRIEF DESCRIPTION OF THE DRAWINGS

FIG. 1 is a schematic diagram of an application scenario of a method for calibrating an FMCW LiDAR according to an embodiment of the present application.

FIG. 2 is a flowchart of an optional method for calibrating an FMCW LiDAR according to an embodiment of the present application.

FIG. 3 is a schematic structural diagram of an FMCW LiDAR with a monitoring link in the prior art.

FIG. 4 is a schematic diagram of another optional method for calibrating an FMCW LiDAR according to an embodiment of the present application.

FIG. 5 is a structural block diagram of an optional FMCW LiDAR (system) according to an embodiment of the present application.

FIG. 6 is a structural block diagram of another FMCW LiDAR (system) according to an embodiment of the present application

FIG. 7 is a diagram of an optional computer system architecture of an electronic device according to an embodiment of the present application.

### DESCRIPTIONS THE EMBODIMENTS

To facilitate the understanding of the present application by the person skilled in the art, the technical solutions of embodiments of the present application will be clearly and completely described below in conjunction with the accompanying drawings. It should be noted that the embodiments described herein are merely part of the embodiments of the present application rather than all embodiments. All other embodiments obtained by the person skilled in the art without paying creative effort based on these embodiments shall fall within the scope of protection of the present application.

It should be noted that terms such as "first" and "second" in the specification, claims, and accompanying drawings of the present application are used to distinguish similar objects and are not intended to describe a specific order or sequence. Such data should be understood to be interchangeable where appropriate, so that the embodiments of the present application described herein may be implemented in an order other than that illustrated or described. Additionally, terms such as "comprise" and "include" and their variants are intended to cover non-exclusive inclusion, meaning that a process, method, system, product, or device including a series of steps or units is not limited to those clearly listed but may include another inherent step or unit not explicitly stated.

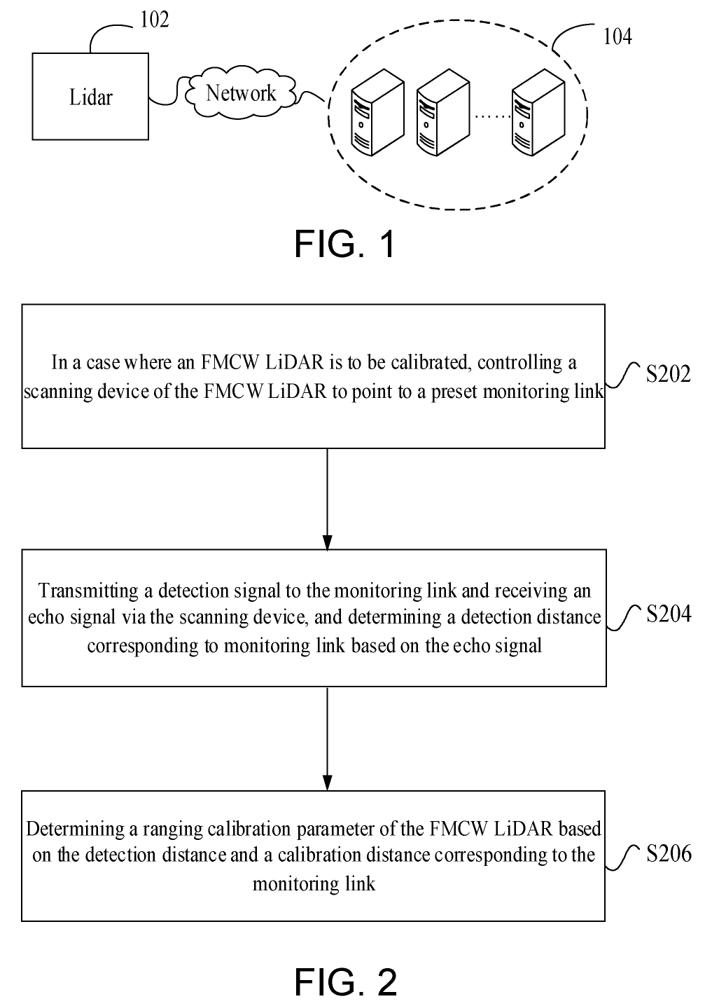

According to an aspect of the present application, a method for calibrating an FMCW LiDAR is provided. Optionally, in this embodiment, the method for calibrating an FMCW LiDAR may be applied to (but not limited to) a hardware environment including a LiDAR 102 and a server 104, as shown in FIG. 1. The server 104 may be connected to the LiDAR 102 via a network and may be configured to provide services (e.g., an application service) to the LiDAR 102 or a terminal device associated with the LiDAR 102. A database may be set up on the server 104 or be deployed independently from the server 104 to provide a data storage service for the server 104.

The network may include, but is not limited to, at least one of the following: a wired network, or a wireless network. The wired network may include, but is not limited to, at least one of the following: a wide area network, a metropolitan area network, a local area network. The wireless network may include, but is not limited to, at least one of the following: WIFI (Wireless Fidelity, wireless fidelity), Bluetooth. The LiDAR 102 may be, but is not limited to, a mechanical LiDAR, a semi-solid-state LiDAR, or a solid-state LiDAR. The server 104 may be, but is not limited to, a cloud server, a server cluster, or a server with another type.

The method for calibrating an FMCW LiDAR provided in embodiments of the present application may be executed by the LiDAR 102 alone or jointly by the LiDAR 102 and the server 104. In an example where the method for calibrating an FMCW LiDAR is executed by the LiDAR 102, FIG. 2 is a flowchart of an optional method for calibrating an FMCW LiDAR according to an embodiment of the present application. As shown in FIG. 2, the method may include the following steps.

Step S202: in a case where an FMCW LiDAR is to be calibrated, controlling a scanning device of the FMCW LiDAR to point to a preset monitoring link, that is, a light emitting direction of the scanning device is controlled to point to the monitoring link, so that the scanning device can transmit a detection signal to the monitoring link.

Step S204: transmitting a detection signal to the monitoring link and receiving an echo signal via the scanning device, and determining a detection distance corresponding to monitoring link based on the echo signal. It can be understood that the FMCW LiDAR further includes a light source, a scanning device, a monitoring link, a detecting module, a data processing module, and a controlling module. During a calibration process, the detection signal provided by the light source is transmitted by the scanning device to the monitoring link, and then the echo signal is formed in the monitoring link. The echo signal is transmitted from the monitoring link to the scanning device, and then received by the scanning device and provided to the detecting module, to form a beat frequency signal after frequency beating. Afterwards, the data processing module in the FMCW LiDAR determines the detection distance corresponding to the monitoring link based on the beat frequency signal.

Step S206: determining a ranging calibration parameter of the FMCW LiDAR based on the detection distance and a calibration distance corresponding to the monitoring link. It can be understood that after the LiDAR is assembled, the monitoring link is fixed within the LiDAR, and a length of an optical path of the monitoring link no longer changes. Thus, a preset detection distance becomes a fixed value, that is, the calibration distance. Therefore, in the present application, the ranging calibration parameter of the LiDAR can be determined based on the detection distance and the calibration distance corresponding to the monitoring link.

The method for calibrating an FMCW LiDAR in the embodiment of the present application may be applied to the field of LiDAR technologies, especially in scenarios where the FMCW LiDAR is used for area detection. It can be understood that the FMCW LiDAR is a LiDAR system that utilizes frequency modulated continuous wave technology. Its core principle is to transmit and receive continuous wave light beams, interfere an echo signal with a local oscillator signal to obtain a beat frequency signal, and calculate a distance and a velocity of a target object based on the beat frequency signal. In FMCW LiDAR design, performance factors such as a transmitting power, a receive gain, and a light source are considered. However, the FMCW LiDAR is susceptible to environmental influences (e.g., different ambient temperatures), which can affect both the laser's linewidth and the DDS hardware circuit, leading to degradation of the measurement accuracy.

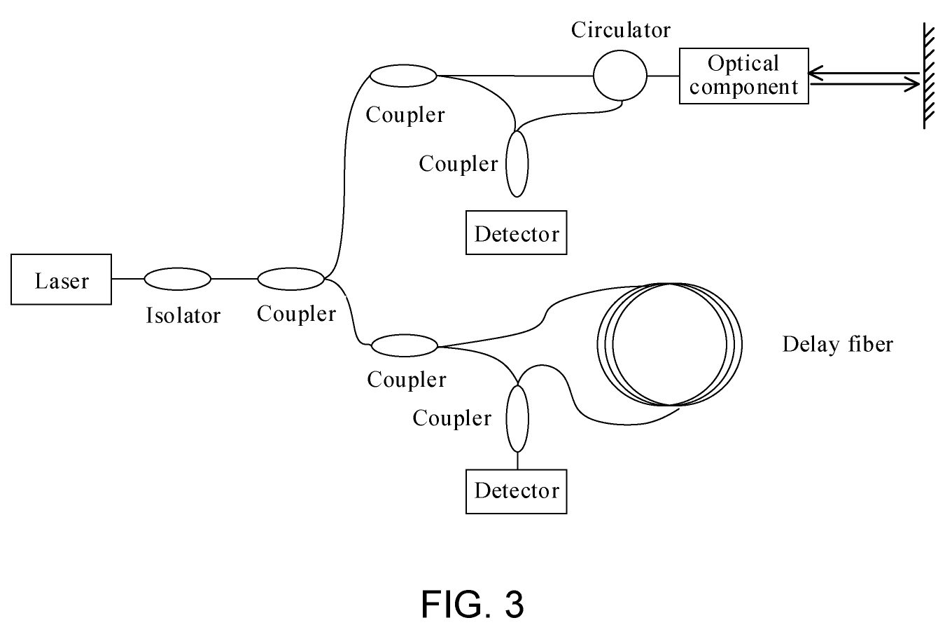

In related technologies, an additional optical path (a monitoring path) needs to be added for distance calculation, to calibrate related component(s) of an FMCW LiDAR. As shown in FIG. 3, an FMCW LiDAR in related technologies includes a laser, an isolator, a coupler, a delay fiber, a circulator, and an optical component. It may further include an ADC (Analog-to-Digital Converter, analog-to-digital converter, for converting an analog signal into a digital signal) and a PD (Photo Detector, photo detector, for converting an optical signal into an electrical signal). This approach of adding the additional optical path increases the structural complexity and costs of the LiDAR system.

To address at least part of the aforementioned technical problem, in this embodiment, one reflection circuit (or multiple reflection circuits) is added at a fixed position within the LiDAR, where the reflection circuit is a monitoring link, specifically a fiber-optic monitoring link or a spatial monitoring link. In a case where the LiDAR is to be calibrated, a beam of the scanning device is controlled to point to a monitoring link (such as a fiber-optic monitoring link) in a fixed direction. A detection signal is transmitted to the fiber-optic monitoring link from the scanning device, and the detection signal is reflected by the fiber-optic monitoring link and entered to the scanning device, and is transmitted to the detecting module, to form an echo signal in the detecting module. Then, a detection distance corresponding to the fiber-optic monitoring link is determined based on the echo signal corresponding to the fiber-optic monitoring link. And a ranging calibration parameter of the LiDAR is determined based on the detection distance and a calibration detection distance corresponding to the fiber-optic monitoring link, so that the ranging calibration parameter for calibrating can be used for ranging calibration in the subsequent detection process. Compared to the scheme of adding an additional monitoring optical path shown in FIG. 3, in the present application, the detection optical path and the monitoring link can be used to achieve monitoring and calibration without an additional optical path, which not only omits a complex optical path and reduces the structural complexity of the LiDAR, but also lowers the calibration cost of the LiDAR.

The FMCW LiDAR may include one or more scanning devices. During a scanning process, the scanning device may receive a detection signal provided by a light source and transmit the detection signal to a detection area to scan the detection area; the scanning device may also receive an echo signal formed by a reflection of the detection signal by an object in the detection area, and provide the echo signal to the detecting module .

In a case where the FMCW LiDAR is to be calibrated, a light emitting direction of the scanning device is controlled to point to the aforementioned fiber-optic monitoring link. The scanning device transmits a detection signal to the fiber-optic monitoring link. A detection distance corresponding the fiber-optic monitoring link is determined based on an echo signal of the fiber-optic monitoring link. Since the fiber-optic monitoring link is arranged at a fixed position within the LiDAR, control parameter(s) of the scanning device may be pre-configured, and the scanning device is controlled based on the pre-configured control parameter(s) to point to a fixed spatial orientation, that is, point to the aforementioned fiber-optic monitoring link.

Since the fiber-optic monitoring link is arranged at a fixed position within the device, a distance between the scanning device and the fiber-optic monitoring link remains constant. Thus, a distance obtained based on the echo signal formed by the reflection of the monitoring link is fixed, that is, the calibration distance. In fact, due to the influence of the working environment, a difference between the detection distance and the calibration distance reflects a degree of environmental influence on the scanning device. A parameter of the LiDAR may be calibrated based on the detection distance and the calibration distance corresponding to the fiber-optic monitoring link. In this embodiment, the ranging calibration parameter of the LiDAR may be determined using the detection distance and the calibration distance corresponding to the fiber-optic monitoring link, so that the ranging calibration parameter can be used in the subsequent for calibrating a detection distance of a target object to obtain an actual distance of the target object.

After the ranging calibration parameter of the LiDAR is determined, the LiDAR is switched to a detection mode to scan a detection space. In the detection mode, the light emitting direction of the scanning device may be controlled to point to the detection space, and target detection can be performed by transmitting a detection signal into the detection space. If a calibration condition (i.e., a condition corresponding to an ambient parameter that needs to be met to calibrate the LiDAR) is met again, the same or similar method as described above may be used for calibration again. Those that have already been explained will not be repeated.

According to the embodiment provided in the present application, in a case where the FMCW LiDAR is to be calibrated, the scanning device is controlled to point to a preset fiber-optic monitoring link. A detection signal is transmitted to the fiber-optic monitoring link via the scanning device. A detection distance corresponding to the fiber-optic monitoring link is determined based on an echo signal of the fiber-optic monitoring link. A ranging calibration parameter of the LiDAR is determined based on the detection distance and a calibration distance corresponding to the fiber-optic monitoring link, to obtain a calibrated specified device parameter. This approach addresses the issues of high structural complexity and high cost of LiDARs in the calibration methods for FMCW LiDARs in related technologies, and reduces the structural complexity and cost of the LiDAR.

In an exemplary implementation, the method further includes: acquiring an ambient temperature of the scanning device collected at a current collection time to obtain a current ambient temperature; and in a case where a temperature difference between the current ambient temperature and a reference ambient temperature is greater than or equal to a preset temperature difference threshold, determining that the LiDAR is to be calibrated, where the reference ambient temperature is an ambient temperature of the scanning device collected at a collection time immediately preceding the current collection time.

The ambient temperature is a key factor affecting a hardware circuit of the FMCW LiDAR, under different temperatures, a laser's linewidth and DDS circuit in the FMCW LiDAR will also be affected at different temperatures. In the FMCW LiDAR, the laser's linewidth represents a coherence of the laser, which determines a theoretical detection distance and a theoretical detection accuracy. Changes in temperature may cause a thermal expansion or contraction in a gain medium, a resonant cavity, or another part of the laser, which in turn affects the propagation and reflection of light, thereby affecting the ranging accuracy.

In this embodiment, whether the LiDAR needs to be calibrated is determined based on the ambient temperature of the scanning device. For this purpose, the ambient temperature of the scanning device collected at the current collection time may be acquired to obtain the current ambient temperature. The collection of the ambient temperatures of the scanning device may be executed periodically, or may be executed in response to a received calibration instruction, or may be based on another execution condition. After obtaining the current ambient temperature, the current ambient temperature may be analyzed to determine whether the LiDAR needs to be calibrated. The analysis of the current ambient temperature may include: inputting the current ambient temperature into a preset analysis model (a neural network model, which can be a classification model), and using the preset analysis model combined with other environmental factor(s) to determine whether the LiDAR needs to be calibrated.

In order to improve the convenience of operation execution and reduce the consumption of storage and computing resources for device calibration, a temperature difference threshold, that is, the preset temperature difference threshold, may be set in advance. If the temperature difference between the current ambient temperature and the reference ambient temperature is greater than or equal to the preset temperature difference threshold, it can be determined that the LiDAR needs to be calibrated; and if the temperature difference between the current ambient temperature and the reference ambient temperature is less than the preset temperature difference threshold, it can be determined that no calibration is required for the LiDAR. Alternatively, if the temperature difference between the current ambient temperature and the reference ambient temperature is less than the preset temperature difference threshold, other environmental factor(s) may be analyzed to further determine whether the LiDAR needs to be calibrated.

For example, a current temperature T can be obtained, and a temperature change ΔT between the current temperature and a temperature collected at a previous collection time may be calculated. If ΔT is greater than a set temperature difference threshold, the LiDAR needs to be calibrated. Exemplarily, the preset temperature difference threshold is 3℃, and after the FMCW LiDAR is started, ambient temperatures are collected every 5 minutes. A current ambient temperature collected at a certain moment is 21℃. If the ambient temperature obtained from the previous collection is 19 ℃, the temperature difference of 2℃ is less than 3℃, and the LiDAR does not need to be calibrated. If the ambient temperature obtained from the previous collection is 15℃, the temperature difference of 6℃ is greater than 3℃, and the LiDAR needs to be calibrated.

Through this embodiment, whether the ranging calibration parameter of the LiDAR needs to be calibrated is determined based on whether the change in the ambient temperatures of the scanning device reaches a set temperature difference threshold, thereby improving the convenience of operation execution and reducing the consumption of storage and computing resources for device calibration.

In an exemplary embodiment, the above method further includes: after acquiring the ambient temperature of the scanning device collected at the current collection time to obtain the current ambient temperature, adjusting, according to a preset correspondence between an ambient temperature and a collection frequency, a collection frequency for collecting ambient temperatures of the scanning device to a target collection frequency corresponding to the current ambient temperature; and acquiring an ambient temperature of the scanning device collected at a next collection time corresponding to the target collection frequency to obtain a next ambient temperature, and determining whether to calibrate the scanning device based on a temperature difference between the next ambient temperature and the current ambient temperature.

The impact of different environments on the scanning device varies. Generally speaking, a higher ambient temperature leads to a more significant variation in the influence on the laser's linewidth and the DDS hardware circuit. Employing a fixed collection frequency may result in untimely calibration or require multiple judgment operations before a single calibration is triggered. In order to improve the rationality of the ambient temperature collection, in this embodiment, the correspondence between ambient temperatures and collection frequencies may be preset, and the collection frequency for ambient temperature can be dynamically adjusted according to the set correspondence.

For the current ambient temperature, the collection frequency for acquiring the ambient temperature of the scanning device may be adjusted to the target collection frequency corresponding to the current ambient temperature, based on the preset correspondence between the ambient temperature and the collection frequency. Here, the correspondence between ambient temperatures and collection frequencies may be represented in the form of a functional equation, or in the form of mapping between temperature ranges and collection frequencies, or in other forms, which is not limited in this embodiment.

In an exemplary embodiment, after acquiring the ambient temperature of the scanning device collected at the current collection time to obtain the current ambient temperature, the method further includes:
adjusting, according to a preset correspondence between at least one ambient temperature and at least one collection frequency, a collection frequency based on the current ambient temperature, and performing temperature collection at the adjusted collection frequency.

For example, when the ambient temperature is between 15℃ and 20℃, the collection frequency is set at once every 15 minutes; when the ambient temperature is between 20℃ and 25℃, the collection frequency is adjusted to once every 10 minutes; when the ambient temperature exceeds 25℃, the collection frequency is increased to once every 5 minutes. If the current ambient temperature collected is 23℃, the collection frequency for ambient temperature is set to once every 10 minutes based on the preset correspondence between the ambient temperature and the collection frequency. After 10 minutes, if an ambient temperature of the scanning device collected is 25℃, the difference between the ambient temperature of the scanning device collected 10 minutes later and the current ambient temperature (23℃) is 2℃. Since this difference is less than the temperature difference threshold of 3℃, it is determined that the scanning device does not need to be calibrated.

Through this embodiment, the collection frequency for ambient temperature is dynamically adjusted according to the set correspondence between the ambient temperature and the collection frequency, thereby improving the rationality of the ambient temperature collection.

In an exemplary embodiment, the determining the detection distance corresponding to the monitoring link based on the echo signal includes: performing frequency beating on the echo signal and a local oscillator signal and performing photoelectric conversion to obtain a beat frequency signal, where the local oscillator signal and the detection signal corresponding to the echo signal are two signals obtained by splitting a same laser beam generated by the scanning device using a beam splitter; and performing frequency analysis on the beat frequency signal, and determining the detection distance corresponding to the fiber-optic monitoring link based on frequency information from the frequency analysis.

In this embodiment, the fiber-optic monitoring links is taken as an example for explanation. When transmitting the detection signal to the fiber-optic monitoring link, the scanning device can split a laser beam via an internal beam splitter into two signals, one is the detection signal and the other is the local oscillator signal. The detection signal is transmitted by a transmitting antenna (the scanning device) to the fiber-optic monitoring link. The transmitted detection signal is reflected by the fiber-optic monitoring link. The signal reflected from the fiber-optic monitoring link is received by the scanning device, yielding the aforementioned echo signal. For the received echo signal, frequency beating is performed on the echo signal and the local oscillator signal to obtain the beat frequency signal. The way to perform frequency beating on the echo signal and the local oscillator signal may be as follows: inputting the echo signal and the local oscillator signal into a mixer, and the mixer mixes the echo signal and the local oscillator signal. As a frequency of the echo signal is altered by a propagation distance and a time delay, while a frequency of the local oscillator signal remains stable, the two are mixed to produce a difference frequency signal, namely the beat frequency signal.

The beat frequency signal contains the frequency difference between the echo signal and the local oscillator signal, which is related to a distance to a target object. Therefore, by performing frequency analysis on the beat frequency signal, the detection distance corresponding to the fiber-optic monitoring link may be determined based on the analyzed frequency information. For example, by conducting a frequency spectrum analysis on the beat frequency signal, the detection distance can be calculated based on a relationship between a peak frequency and a target distance, as well as a peak frequency in the analyzed frequency spectrum.

In an exemplary embodiment, the scanning device may be a phased-array antenna or an optical lens group. When the scanning device is the phased-array antenna, an emitting direction of the phased-array antenna may be controlled by adjusting a phase of a detection signal in the antenna, so that the detection signal may be transmitted to the monitoring link when need to be calibrated. The optical lens group may be a MEMS galvanometer, which rotates by modifying a driving signal of the MEMS to transmit a detection signal to the monitoring link. The optical lens group may also be a mechanical scanning device, which rotates by modifying a motor driving signal to transmit a light beam to the monitoring link.

In an embodiment, there are a plurality of monitoring links with different lengths fixedly arranged in the FMCW LiDAR, each of the monitoring links corresponds to a detection distance range, so that a detection distance within different ranging ranges may be accurately calibrated by using different monitoring links, thereby improving the ranging accuracy. For example, when there are a plurality of monitoring links fixed in the LiDAR, and lengths of different monitoring links are different, if ΔT is greater than a temperature difference threshold, the scanning device is controlled to point to a fixed angle (ang), that is, to transmit to one monitoring link, and the detection signal transmitted to the monitoring link forms an echo signal after being returned via the monitoring link. Then, a distance D_CUR (i.e., the detection distance) is calculated based on the echo signal and the local oscillator signal, and the ranging calibration parameter is calculated according to the D_CUR and the calibration distance corresponding to the monitoring link.

Through this embodiment, in the case where the LiDAR is to be calibrated, the collimating and focusing of the scanning device is controlled to point to the fiber-optic monitoring link, thereby improving the ease of device control, and further enhancing the efficiency of device calibration.

In an exemplary embodiment, the determining the ranging calibration parameter of the LiDAR based on the detection distance and the calibration distance corresponding to the monitoring link includes: determining and updating a ratio between the detection distance and the calibration distance as the ranging calibration parameter of the LiDAR.

In this embodiment, the calculated ratio between the detection distance and the calibration distance is determined as the ranging calibration parameter. In other embodiments, the ratio between the detection distance and the calibration distance may also be calculated, and a product of the calculated ratio and a current parameter value of the ranging calibration parameter of the LiDAR may be determined as the calibrated current parameter value. Other calibration methods may also be used, provided they can ensure that the detection accuracy after calibration is higher than that before calibration. Here, after the current ranging calibration parameter (i.e., the calibrated ranging calibration parameter) is calculated, the ranging calibration parameter of the LiDAR may be updated to be the calculated current ranging calibration parameter.

Through this embodiment, the calculated ratio between the detection distance and the calibration distance serves as the basis for updating the ranging calibration parameter, thereby improving the ease of device calibration, and further maintaining the accuracy and reliability of the measurement result.

In an exemplary embodiment, for a case where there are a plurality of scanning devices, ranging calibration parameters corresponding to optical channel of different scanning devices may be different, thus each scanning device may be configured with a corresponding fiber-optic monitoring link. However, a plurality of fiber-optic monitoring links not only increase the structural complexity of the LiDAR, but also increase the cost of the LiDAR. In order to reduce the structural complexity and cost of the LiDAR, the plurality of scanning devices may share the same fiber-optic monitoring link, if all the scanning devices use light sources of the same wavelength, only one scanning device is allowed to use the fiber-optic monitoring link at a given time, that is, different scanning devices correspond to different enablement time periods.

Correspondingly, the above method further includes: within an enablement time period corresponding to each of the plurality of scanning devices, respectively determining whether to calibrate each of the plurality of scanning devices, if necessary, a ranging parameter of an optical channel corresponding to said scanning device is calibrated. The enablement time periods for two adjacent scanning devices can be either contiguous or non-contiguous, as long as it ensures that only one scanning device is allowed to use the fiber-optic monitoring link at a given time. This approach enables the monitoring and calibration functionality for multiple lasers under a single set of optical path conditions.

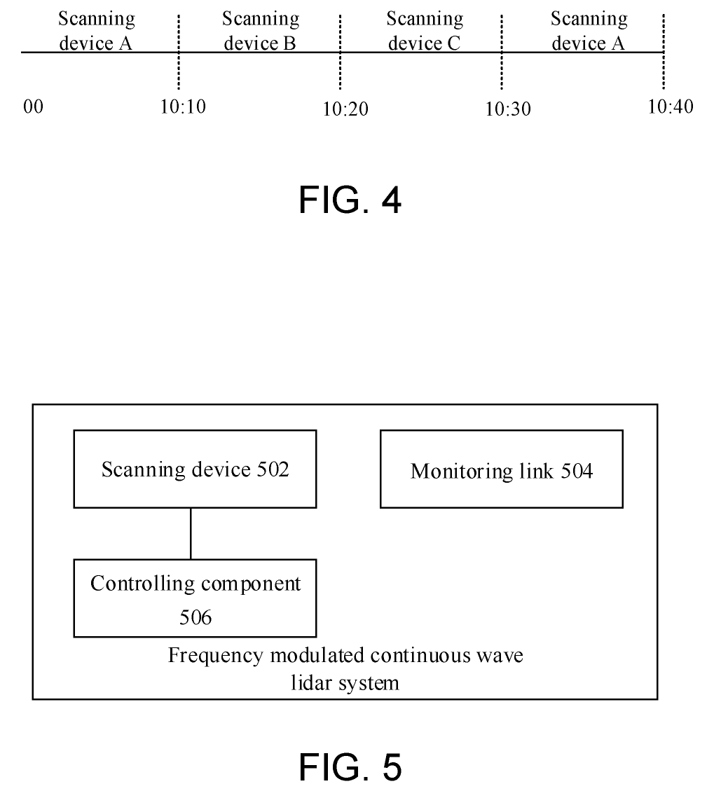

For example, as shown in FIG. 4, the FMCW LiDAR includes three scanning devices: a scanning device A, a scanning device B, and a scanning device C. Each scanning device has an enablement time period of 10 minutes, where the scanning device A has an enablement time period of 10:00-10:10, the scanning device B has an enablement time period of 10:10-10:20, and the scanning device C has an enablement time period of 10:20-10:30. The three scanning devices operate in sequence and repeat this cycle continuously. During their respective enablement time periods, the scanning device may use this fiber-optic monitoring link for a calibration operation.

Through this embodiment, multiple scanning devices share the same set of fiber-optic monitoring link, thereby achieving calibration of the multiple scanning devices while reducing the structural complexity and cost of the LiDAR. Furthermore, different scanning devices correspond to different enablement time periods (i.e., the time periods during which each scanning device is permitted to use the fiber-optic monitoring link), thereby avoiding signal interference among different scanning devices.

In an exemplary embodiment, there are a plurality of scanning devices and each corresponds to a light source of a different wavelength; the method further includes:
controlling light beams of the plurality of scanning devices to point to the monitoring link simultaneously or time-divisionally, and adjusting, using the monitoring link, a ranging calibration parameter of an optical channel corresponding to each of the scanning devices; where the plurality of scanning devices share the monitoring link.

In an exemplary embodiment, when the FMCW LiDAR is in a detection mode, the method further includes:
controlling the light emitting direction of the scanning device to point to a detection space, and scanning the detection space to obtain a detection distance of a target object in the detection space;
calibrating the detection distance of the target object by using the ranging calibration parameter to determine an actual distance of the target object.

It should be noted that for the above method embodiments, they are all described as a series of action combinations to simplify the description. However, the person skilled in the art should be aware that the present application is not limited by the order of the described actions, as certain steps may be performed in other orders or simultaneously according to the present application. Secondly, the person skilled in the art should also be aware that the embodiments described in the specification are all preferred embodiments, and the actions and modules involved are not necessarily required for the present application.

Through the description of the above embodiments, the person skilled in the art can clearly understand that the method according to the above embodiments can be implemented through software and a necessary general hardware platform, or through hardware. However, in many cases, the former is a better implementation. Based on this understanding, the technical solution of the present application, essentially or the part that contributes to the existing technology, can be embodied in the form of a software product. The computer software product is stored in a storage medium (such as, a ROM (Read Only Memory, read only memory)/ a RAM (Random Access Memory, random access memory), a magnetic disk, or a compact disc), and includes several instructions to enable a terminal device (which may be a mobile phone, a computer, a server, or a network device, and etc.) to execute the methods described in various embodiments of the present application.

Based on the same conceptual design, according to another aspect of the embodiments of the present application, an FMCW LiDAR (system) is further provided. The LiDAR (system) can be used to implement the method for calibrating an FMCW LiDAR provided in the above embodiments, which has already explained and will not be repeated. As used below, the term “module” may refer to a combination of software and/or hardware that implements predetermined functions. Although the devices described in the following embodiments are preferably implemented in software, an implementation with hardware or a combination of software and hardware is also possible and envisioned.

FIG. 5 is a structural block diagram of an optional FMCW LiDAR (system) according to an embodiment of the present application. As shown in FIG. 5, the FMCW LiDAR (system) includes a scanning device 502, a monitoring link 504, and a controlling component 506. The controlling component 506 is configured to control a light emitting direction of the scanning device to point to the monitoring link 504, in a case where the LiDAR is to be calibrated; control the scanning device to transmit a detection signal to the monitoring link 504 and receive an echo signal from the monitoring link 504, and determine a detection distance corresponding to the monitoring link 504 based on the echo signal; so that a ranging calibration parameter of the LiDAR may be determined based on the detection distance and a calibration distance corresponding to the monitoring link. The scanning device 502 is configured to lead the light emitting direction thereof to point to the monitoring link in response to the control of the controlling component; and transmit the detection signal to the monitoring link and receive the echo signal of the fiber-optic monitoring link.

It should be noted that the controlling component 506 in this embodiment may be configured to perform step S202 and step S204 in the above embodiments.

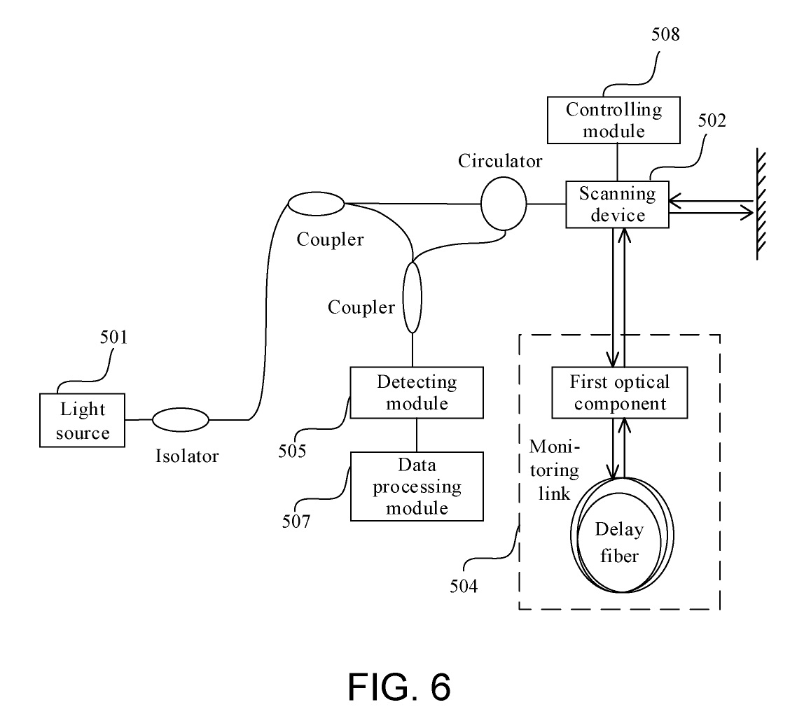

In an exemplary embodiment, the FMCW LiDAR (system) further includes a light source 501 and a detecting module 505, and the control component 506 includes a data processing module 507 and a controlling module 508. As shown in FIG. 6, the FMCW LiDAR (system) includes: a light source 501, a scanning device 502, a monitoring link 504, a detecting module 505, a data processing module 507, and a controlling module 508. Among them, the controlling module 508 is configured to control a light emitting direction of the scanning device to point to the monitoring link 504 in a case where the LiDAR is to be calibrated; the light source is configured to provide a detection signal to the scanning device 502; the scanning device 502 is configured to transmit the detection signal to the monitoring link 504, and receive an echo signal, where the echo signal is formed after the detection signal passes through the monitoring link 504; the detecting module 505 receives the echo signal, and perform frequency beating and photoelectric conversion on the echo signal to generate a beat frequency signal; the data processing module 507 is configured to receive the beat frequency signal, determine the detection distance corresponding to the monitoring link according to the beat frequency signal, and determine the ranging calibration parameter of the LiDAR based on the detection distance and a calibration distance corresponding to the monitoring link.

In an exemplary embodiment, the monitoring link 504 includes a fiber-optic monitoring link or a spatial monitoring link. Among them, the fiber-optic monitoring link may include a section of delay fiber and a first optical component. Specifically, the detection signal is coupled to the fiber via the first optical component. After passing through the fiber, the detection signal forms an echo signal and is transmitted to the first optical component, and then the echo signal is transmitted by the first optical component to the scanning device 502. The spatial monitoring link includes an optical circulator. Specifically, the detection signal is received via one of ports of the optical circulator. After passing through the optical circulator, an echo signal is formed based on the detection signal, and is transmitted to the scanning device 502 via another port of the optical circulator. In addition, the fiber-optic monitoring link and the spatial monitoring link may further include other devices, which is not limited here.

In an exemplary embodiment, there are a plurality of monitoring links with different lengths fixedly arranged in the FMCW LiDAR, and each of the monitoring links is configured to determine a ranging calibration parameter corresponding to a single detection distance range.

In the FMCW LiDAR (system) shown in FIG. 6, assuming that the monitoring links includes a first fiber-optic monitoring link (not shown) and a second fiber-optic monitoring link (not shown); where detection ranges corresponding to the first fiber-optic monitoring link and the second fiber-optic monitoring link are 50m–100m and 150m–200m, respectively. In the case where the LiDAR is to be calibrated, the controlling component 502 controls the scanning device 502 to point to the first fiber-optic monitoring link and receives an echo signal corresponding to the first fiber-optic monitoring link, so that the detection distance may be calculated according to the echo signal, and the ranging calibration parameter is further determined based on the detection distance and a calibration distance of the first fiber-optic monitoring link. Similarly, the ranging parameter is determined based on the detection distance and a calibration distance of the second fiber-optic monitoring link. In the subsequent target detection processes, if a detection distance of a target object is 180m, the ranging calibration parameter obtained via the second fiber-optic monitoring link is adopted to calibrate the detection distance of the target object, thereby improving the ranging accuracy.

In some embodiments, the LiDAR includes a plurality of light sources of different wavelengths, there are a plurality of scanning devices and one monitoring link; the scanning devices are in one-to-one correspondence with the light sources; the control component is configured to control light beams of the plurality of the scanning devices to point to the monitoring link simultaneously or in a time-division manner, and adjust, using the monitoring link, a ranging calibration parameter of an optical channel corresponding to each of the scanning devices. In other embodiments, the LiDAR includes a light source; there are a plurality of scanning devices and one monitoring link; where the monitoring link is shared among the plurality of scanning devices, and the monitoring link is used by one scanning device for calibrating at a time. For the specific operation principle of the LiDAR when it includes a plurality of scanning devices, reference may be made to the above content, which will not be repeated here.

In an exemplary embodiment, the scanning device includes a phased-array antenna or an optical lens group. Please refer to the above content for specific structural settings and working methods, which will not be repeated here.

In an exemplary embodiment, the system further includes a temperature sensor, where the temperature sensor is configured to monitor an ambient temperature of the scanning device; the controlling component is further configured to acquire the ambient temperature of the scanning device detected by the temperature sensor at a current collection time; and in a case where a temperature difference between the current ambient temperature and a reference ambient temperature is greater than or equal to a preset temperature difference threshold, determine that the LiDAR is to be calibrated, where the reference ambient temperature is an ambient temperature of the scanning device collected at a previous collection time preceding the current collection time.

In an exemplary embodiment, the data processing module is further configured to determine a ratio between the detection distance and the calibration distance as the ranging calibration parameter. In other embodiments, the ratio between the detection distance and the calibration distance may also be calculated, and a product of the calculated ratio and a current parameter value of the ranging calibration parameter of the LiDAR may be determined as the calibrated current parameter value. Other calibration methods may also be used, provided they can ensure that the detection accuracy after calibration is higher than that before calibration. Here, after the current ranging calibration parameter (i.e., the calibrated ranging calibration parameter) is calculated, the ranging calibration parameter of the LiDAR may be updated to be the calculated current ranging calibration parameter.

It should be noted that the above modules may be implemented through software or hardware. For the latter, they can be implemented through the following manners, but not limited to: all of the aforementioned modules being located in the same processor; or the aforementioned modules being located in different processors in any combination.

According to another aspect of the embodiments of the present application, a computer-readable storage medium is provided, which stores a program, when run, performs steps in any of the method embodiments described above.

In an exemplary embodiment, the computer-readable storage medium may include but is not limited to: various media which can store a computer program, such as, a USB flash, a ROM, a RAM, a portable hard drive, a magnetic disk, or a compact disc.

According to another aspect of the embodiments of the present application, an electronic device is provided, including a memory, a processor, and a computer program stored on the memory and executable on the processor. The processor is configured to execute steps in any of the method embodiments through the computer program. In an exemplary embodiment, the electronic device may further include a transmission device and an input-output device, where the transmission device is connected to the processor, and the input-output device is connected to the processor.

For specific examples in this embodiment, reference can be made to the examples described in the above embodiments and exemplary embodiments, which will not be repeated here.

According to another aspect of the embodiments of the present application, a computer program product is further provided, including a computer program/instructions, the computer program/instructions includes program codes for executing the method shown in the flowchart. In such embodiments, the computer program may be downloaded and installed from a network through a communication section 609, and/or installed from a removable medium 611. When the computer program is executed by a central processing unit 601, various functions provided by the embodiments of the present application are executed. The numbers for the aforementioned embodiments are for description only and do not represent the advantages or disadvantages of the embodiments.

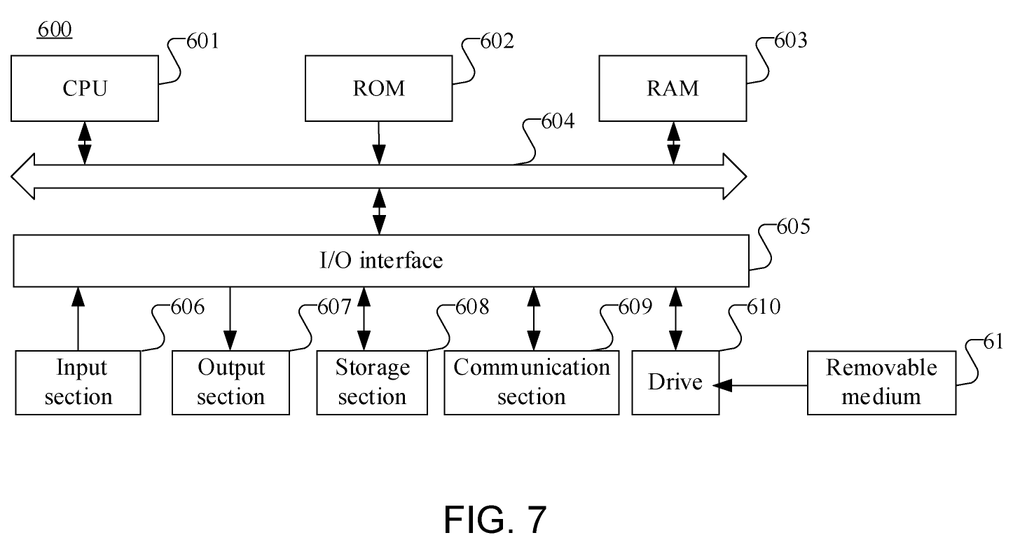

FIG. 7 shows a schematic diagram of a computer system architecture of an electronic device used to implement the embodiments of the present application. As shown in FIG. 7, the computer system 600 includes a CPU (Central Processing Unit, central processing unit) 601, which may execute various appropriate actions and processing based on a program stored in a ROM 602 or a program loaded from a storage section 608 into the RAM 603. In a random access memory 603, various programs and data required for system operations are also stored. The central processing unit 601, the read only memory 602, and the random access memory 603 are connected to each other through a bus 604. An I/O (Input/Output, input/output) interface 605 is also connected to the bus 604.

The following components are connected to the I/O interface 605: an input section 606 including a keyboard, a mouse, and etc.; an output section 607 including a CRT (Cathode Ray Tube, cathode ray tube), an LCD (Liquid Crystal Display, a liquid crystal display), and a speaker; a storage section 608 including a hard drive; and a communication section 609 including a network interface card, such as, a local area network card, a modem, and etc. The communication section 609 performs communication processing via a network such as the Internet. A drive 610 is also connected to the input/output interface 605 as needed. A removable medium 611, such as, a magnetic disk, a compact disc, a magnetic compact disc, a semiconductor storage device, and etc., are installed on the drive 610 as needed, so that the computer program read from them can be installed into the storage section 608 as needed.

Specifically, according to the embodiments of the present application, the processes described in each method flowchart may be implemented as a computer software program. For example, an embodiment of the present application includes a computer program product including a computer program carried on a computer-readable medium, the computer program including program codes for executing the method shown in the flowchart. In such embodiment, the computer program may be downloaded and installed from a network through the communication section 609, and/or installed from the removable medium 611. When the computer program is executed by the central processing unit 601, various functions defined in the system of the present application are executed.

It should be noted that the computer system of the electronic device 600 shown in FIG. 7 is only an example and should not impose any limitations on the functionality and scope of use of the embodiments of the present application.

Obviously, the person skilled in the art should understand that modules or steps of the present application described above may be implemented by means of a general-purpose computing device, and may be centralized on a single computing device or distributed across a network composed of multiple computing devices. The modules or steps of the present application may be implemented as program codes executable by the computing device, so that the program codes may be stored in a storage device for execution by the computing device. In some cases, the steps shown or described may be executed in a different order from that described herein, or they may each be fabricated into various integrated circuit modules, or multiple modules or steps thereof can be integrated into a single integrated circuit module for implementation. Thus, the present application is not limited to any specific combination of hardware and software.

The foregoing descriptions are merely preferred embodiments of the present application and are not intended to limit the present application. For the person skilled in the art, various modifications and variations to the present application are possible. Any modifications, equivalent substitutions, improvements, and the like that made within the principle of the present application shall be included within the scope of protection of the present application.

What is claimed is:

1. A method for calibrating a frequency modulated continuous wave (FMCW) LiDAR, comprising:
in a case where the FMCW LiDAR is to be calibrated, controlling a light emitting direction of a scanning device of the FMCW LiDAR to point to a preset monitoring link;
transmitting a detection signal to the monitoring link and receiving an echo signal via the scanning device, and determining a detection distance corresponding to the monitoring link based on the echo signal, wherein the echo signal is formed after the detection signal passes through the monitoring link;
determining a ranging calibration parameter of the FMCW LiDAR based on the detection distance and a calibration distance corresponding to the monitoring link.

2. The method according to claim 1, wherein the monitoring link comprises a fiber-optic monitoring link or a spatial monitoring link; during a calibration process, the detection signal transmitted by the scanning device enters the fiber-optic fiber monitoring link or the spatial monitoring link, the echo signal is formed after the detection signal passes through the fiber-optic monitoring link or the spatial monitoring link, and the echo signal is transmitted from the monitoring link to the scanning device.

3. The method according to claim 1, further comprising:
acquiring an ambient temperature of the scanning device collected at a current collection time to obtain a current ambient temperature;
in a case where a temperature difference between the current ambient temperature and a reference ambient temperature is greater than or equal to a preset temperature difference threshold, determining that the FMCW LiDAR is to be calibrated, wherein the reference ambient temperature is an ambient temperature of the scanning device collected at a previous collection time preceding the current collection time.

4. The method according to claim 3, wherein after acquiring the ambient temperature of the scanning device collected at the current collection time to obtain the current ambient temperature, the method further comprises:
adjusting, according to a preset correspondence between at least one ambient temperature and at least one collection frequency, a collection frequency based on the current ambient temperature, and performing temperature collection at the adjusted collection frequency.

5. The method according to claim 1, wherein the determining the detection distance corresponding to the fiber-optic monitoring link based on the echo signal comprises:
performing frequency beating on the echo signal and a local oscillator signal to obtain a beat frequency signal;
performing frequency analysis on the beat frequency signal, and determining the detection distance corresponding to the monitoring link based on frequency information from the frequency analysis.

6. The method according to claim 1, wherein when the FMCW LiDAR is in a detection mode, the method further comprises:
controlling the light emitting direction of the scanning device to point to a detection space, and scanning the detection space to obtain a detection distance of a target object in the detection space;
calibrating the detection distance of the target object by using the ranging calibration parameter to determine an actual distance of the target object.

7. The method according to claim 1, wherein there are a plurality of scanning devices using light sources of a same wavelength; the method further comprises:
within an enablement time period corresponding to each of the plurality of scanning devices, respectively determining whether to calibrate the FMCW LiDAR, wherein the monitoring link is shared among the plurality of scanning devices, and the monitoring link is used by one scanning device for the calibration of the FMCW LiDAR at a time.

8. The method according to claim 1, wherein there are a plurality of scanning devices and each of the plurality of scanning devices corresponds to a light source of a different wavelength; the method further comprises:
controlling light beams of the plurality of scanning devices to point to the monitoring link simultaneously or time-divisionally, and adjusting, using the monitoring link, a ranging calibration parameter of an optical channel corresponding to each of the plurality of scanning devices;
wherein the plurality of scanning devices share the monitoring link.

9. The method according to claim 1, wherein there are a plurality of monitoring links with different lengths fixedly arranged in the FMCW LiDAR, and each of the plurality of monitoring links corresponds to a different detection distance range;
wherein the scanning device is configured to use one of the plurality of monitoring links for the calibration of the FMCW LiDAR at a time.

10. A frequency modulated continuous wave (FMCW) LiDAR, comprising: a scanning device, a monitoring link, and a controlling component;
wherein the controlling component is configured to in a case where the FMCW LiDAR is to be calibrated, control a light emitting direction of the scanning device to point to the monitoring link; control the scanning device to transmit a detection signal to the monitoring link and receive an echo signal from the monitoring link, and determine an detection distance corresponding to the monitoring link based on the echo signal; and determine a ranging calibration parameter of the FMCW LiDAR.

11. The FMCW LiDAR according to claim 10, further comprising: a light source and a detecting module; and the controlling component comprises a data processing module and a controlling module;
wherein the controlling module is configured to control the light emitting direction of the scanning device to point to the monitoring link in the case where the FMCW LiDAR is to be calibrated;
the light source is configured to provide the detection signal to the scanning device;
the scanning device is configured to transmit the detection signal to the monitoring link, and receive the echo signal; wherein the echo signal is formed after the detection signal passes through the monitoring link;
the detecting module is configured to receive the echo signal, and perform frequency beating and photoelectric conversion on the echo signal to generate a beat frequency signal;
the data processing module is configured to receive the beat frequency signal, determine the detection distance corresponding to the monitoring link according to the beat frequency signal, and determine the ranging calibration parameter of the FMCW LiDAR based on the detection distance and a calibration distance corresponding to the monitoring link.

12. The FMCW LiDAR according to claim 10, wherein the monitoring link comprises a fiber-optic monitoring link or a spatial monitoring link;
wherein the fiber-optic monitoring link comprises a section of fiber and a first optical component; the spatial monitoring link comprises an optical circulator.

13. The FMCW LiDAR according to claim 10, further comprising a temperature sensor;
wherein the temperature sensor is configured to collect an ambient temperature of the scanning device to obtain a current ambient temperature, and send the current ambient temperature to the controlling component;
the controlling component is further configured to determine that the FMCW LiDAR is to be calibrated in a case where a temperature difference between the current ambient temperature and a reference ambient temperature is greater than or equal to a preset temperature difference threshold, wherein the reference ambient temperature is an ambient temperature of the scanning device collected at a previous collection time preceding the current collection time.

14. The FMCW LiDAR according to claim 10, further comprising a light source; there are a plurality of scanning devices and one monitoring link;
wherein the monitoring link is shared among the plurality of scanning devices, and the monitoring link is used by one scanning device for the calibration of the FMCW LiDAR at a time.

15. The FMCW LiDAR according to claim 10, further comprising a plurality of light sources of different wavelengths, there are a plurality of scanning devices and one monitoring link; the scanning devices are in one-to-one correspondence with the light sources; the control component is configured to control light beams of the plurality of the scanning devices to point to the monitoring link simultaneously or time-divisionally, and adjust, using the monitoring link, a ranging calibration parameter of an optical channel corresponding to each of the scanning devices.

16. The FMCW LiDAR according to claim 10, wherein there are a plurality of monitoring links with different lengths fixedly arranged in the FMCW LiDAR, and each of the plurality of monitoring links is used for determining a ranging calibration parameter corresponding to a single detection distance range.

17. The FMCW LiDAR according to claim 10, wherein the scanning device comprises a phased-array antenna or an optical lens group.

18. A non-transitory computer-readable storage medium, storing a computer program configured to execute method according to claim 1 when running.
